(19) United States
(12) Patent Application Publication
(10) Pub. No.: US 2013/0106699 A1
(43) Pub. Date: May 2, 2013

(54) PORTABLE ELECTRONIC DEVICE AND METHOD OF CHARACTER ENTRY

(71) Applicant: Abdul-Rasheed BABATUNDE, Irving, TX (US)

(72) Inventor: Abdul-Rasheed BABATUNDE, Irving, TX (US)

(73) Assignee: RESEARCH IN MOTION LIMITED, Waterloo (CA)

(21) Appl. No.: 13/281,934

(22) Filed: Oct. 26, 2011

(51) Int. Cl. G06F 3/02

(52) U.S. Cl. 345/168

(57) ABSTRACT

A method of controlling an electronic device, the method comprising displaying a plurality of keys on a touch-sensitive display, detecting a touch at a touch location associated with a first key of the plurality of keys, identifying a touch response, and when a force associated with the touch meets a threshold, entering a primary character associated with the first key when the touch response is primary character entry, entering a secondary character associated with the first key when the touch response is secondary character entry.

### FIELD OF TECHNOLOGY

The present disclosure relates to electronic devices, including but not limited to, portable electronic devices having touch-sensitive displays and their control.

### BACKGROUND

Electronic devices, including portable electronic devices, have gained widespread use and may provide a variety of functions including, for example, telephonic, electronic messaging and other personal information manager (PIM) application functions. Portable electronic devices include, for example, several types of mobile stations such as simple cellular telephones, smart telephones, wireless personal digital assistants (PDAs), and laptop computers with wireless 802.11 or Bluetooth capabilities.

Portable electronic devices such as PDAs or smart telephones are generally intended for handheld use and ease of portability. Smaller devices are generally desirable for portability. A touch-sensitive display, also known as a touchscreen display, is particularly useful on handheld devices, which are small and have limited space for user input and output. The information displayed on the touch-sensitive displays may be modified depending on the functions and operations being performed. With continued demand for decreased size of portable electronic devices, touch-sensitive displays continue to decrease in size.

Improvements in devices with touch-sensitive displays are desirable.

### BRIEF DESCRIPTION OF THE DRAWINGS

FIG. 1 is a block diagram of a portable electronic device in accordance with the disclosure.

FIG. 2 is a sectional side view of an example of a portable electronic device in accordance with the disclosure.

FIG. 3 is a sectional side view of an example of a portable electronic device in accordance with the disclosure.

FIG. 4 is a sectional side view of a piezoelectric actuator in accordance with the disclosure.

FIG. 5 is a sectional side view of a piezoelectric actuator with a force sensor in accordance with the disclosure.

FIG. 6 is a block diagram including force sensors and actuators of the portable electronic device in accordance with the disclosure.

FIG. 7. and FIG. 8 are front views of an example of a portable electronic device in accordance with the disclosure.

FIG. 9 is a front view of a portable electronic device displaying a keyboard in accordance with the disclosure.

FIG. 10 is a flowchart illustrating an example of a method of character entry for a portable electronic device in accordance with the disclosure.

FIG. 11, FIG. 12, FIG. 13, and FIG. 14 illustrate examples of character entry in accordance with the disclosure.

FIG. 15 is a front view of another example of a portable electronic device displaying a keyboard in accordance with the disclosure.

### DETAILED DESCRIPTION

The following describes a portable electronic device and a method that includes displaying a plurality of keys on a touch-sensitive display, detecting a touch at a touch location associated with a first key of the plurality of keys, identifying a touch response, and when a force associated with the touch meets a threshold, entering a primary character associated with the first key when touch response is primary character entry, entering a secondary character associated with the first key when the touch response is secondary character entry.

For simplicity and clarity of illustration, reference numerals may be repeated among the figures to indicate corresponding or analogous elements. Numerous details are set forth to provide an understanding of the embodiments described herein. The embodiments may be practiced without these details. In other instances, well-known methods, procedures, and components have not been described in detail to avoid obscuring the embodiments described. The description is not to be considered as limited to the scope of the embodiments described herein.

The disclosure generally relates to an electronic device, which is a portable electronic device in the embodiments described herein. Examples of portable electronic devices include mobile, or handheld, wireless communication devices such as pagers, cellular phones, smartphones, wireless organizers, personal digital assistants, wirelessly enabled notebook computers, tablet computers, mobile internet devices, electronic navigation devices, and so forth. The portable electronic device may also be a portable electronic device without wireless communication capabilities, such as a handheld electronic game device, digital photograph album, digital camera, media player, e-book reader, and so forth.

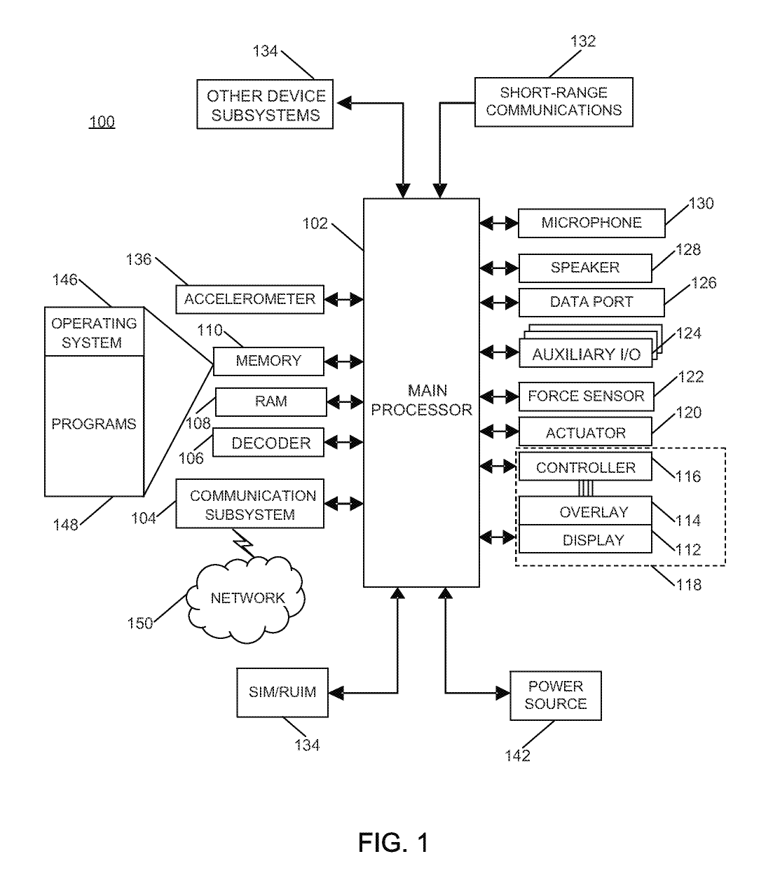

A block diagram of an example of a portable electronic device 100 is shown in FIG. 1. The portable electronic device 100 includes multiple components, such as a processor 102 that controls the overall operation of the portable electronic device 100. Communication functions, including data and voice communications, are performed through a communication subsystem 104. Data received by the portable electronic device 100 is decompressed and decrypted by a decoder 106. The communication subsystem 104 receives messages from and sends messages to a wireless network 150. The wireless network 150 may be any type of wireless network, including, but not limited to, data wireless networks, voice wireless networks, and networks that support both voice and data communications. A power source 142, such as one or more rechargeable batteries or a port to an external power supply, powers the portable electronic device 100.

The processor 102 interacts with other components, such as Random Access Memory (RAM) 108, memory 110, a display 112 with a touch-sensitive overlay 114 operably connected to an electronic controller 116 that together comprise a touch-sensitive display 118, an auxiliary input/output (I/O) subsystem 124, a data port 126, a speaker 128, a microphone 130, short-range communications 132, and other device subsystems 134. The processor 102 may interact with one or more force sensors 122. The processor 102 may optionally interact with one or more actuators 120. Interaction with a graphical user interface is performed through the touch-sensitive overlay 114. The processor 102 interacts with the touch-sensitive overlay 114 via the electronic controller 116. Information, such as text, characters, symbols, images, icons, and other items that may be displayed or rendered on a portable electronic device, is displayed on the touch-sensitive display 118 via the processor 102. The processor 102 may interact with an accelerometer 136 that may be utilized to detect direction of gravitational forces or gravity-induced reaction forces.

To identify a subscriber for network access, the portable electronic device 100 uses a Subscriber Identity Module or a Removable User Identity Module (SIM/RUIM) card 138 for communication with a network, such as the wireless network 150. Alternatively, user identification information may be programmed into memory 110.

The portable electronic device 100 includes an operating system 146 and software programs or components 148 that are executed by the processor 102 and are typically stored in a persistent, updatable store such as the memory 110. Additional applications or programs may be loaded onto the portable electronic device 100 through the wireless network 150, the auxiliary I/O subsystem 124, the data port 126, the short-range communications subsystem 132, or any other suitable subsystem 134.

A received signal such as a text message, an e-mail message, or web page download is processed by the communication subsystem 104 and input to the processor 102. The processor 102 processes the received signal for output to the display 112 and/or to the auxiliary I/O subsystem 124. A subscriber may generate data items, for example e-mail messages, which may be transmitted over the wireless network 150 through the communication subsystem 104. For voice communications, the overall operation of the portable electronic device 100 is similar. The speaker 128 outputs audible information converted from electrical signals, and the microphone 130 converts audible information into electrical signals for processing.

The touch-sensitive display 118 may be any suitable touch-sensitive display, such as a capacitive, resistive, infrared, surface acoustic wave (SAW) touch-sensitive display, strain gauge, optical imaging, dispersive signal technology, acoustic pulse recognition, and so forth, as known in the art. A capacitive touch-sensitive display may include a capacitive touch-sensitive overlay 114. The overlay 114 may be an assembly of multiple layers in a stack including, for example, a substrate, a ground shield layer, a barrier layer, one or more capacitive touch sensor layers separated by a substrate or other barrier, and a cover. The capacitive touch sensor layers may be any suitable material, such as patterned indium tin oxide (ITO).

One or more touches, also known as touch contacts or touch events, may be detected by the touch-sensitive display 118. The processor 102 may determine attributes of the touch, including a location of a touch. Touch location data may include an area of contact or a single point of contact, such as a point at or near a center of the area of contact. The location of a detected touch may include x and y components, e.g., horizontal and vertical components, respectively, with respect to one's view of the touch-sensitive display 118. For example, the x and y components may be determined by signals generated from the touch-sensor layers, also referred to as touch sensors. A signal is provided to the controller 116 in response to detection of a touch. A touch may be detected from any suitable input member, such as a finger, thumb, appendage, or other objects, for example, a stylus, pen, or other pointer, depending on the nature of the touch-sensitive display 118. The controller 116 and/or the processor 102 may detect a touch by any suitable input member on the touch-sensitive display 118. Multiple simultaneous touches may be detected.

One or more gestures may also be detected by the touch-sensitive display 118. A gesture, such as a swipe, also known as a flick, is a particular type of touch on a touch-sensitive display 118 that begins at an origin point and continues to an end point. A gesture may be identified by attributes of the gesture, including the origin point, the end point, the distance traveled, the duration, the velocity, and the direction, for example. A gesture may be long or short in distance and/or duration. Two points of the gesture may be utilized to determine a direction of the gesture. A hover may be a touch at a location that is generally unchanged over a period of time or is associated with the same selection item for a period of time.

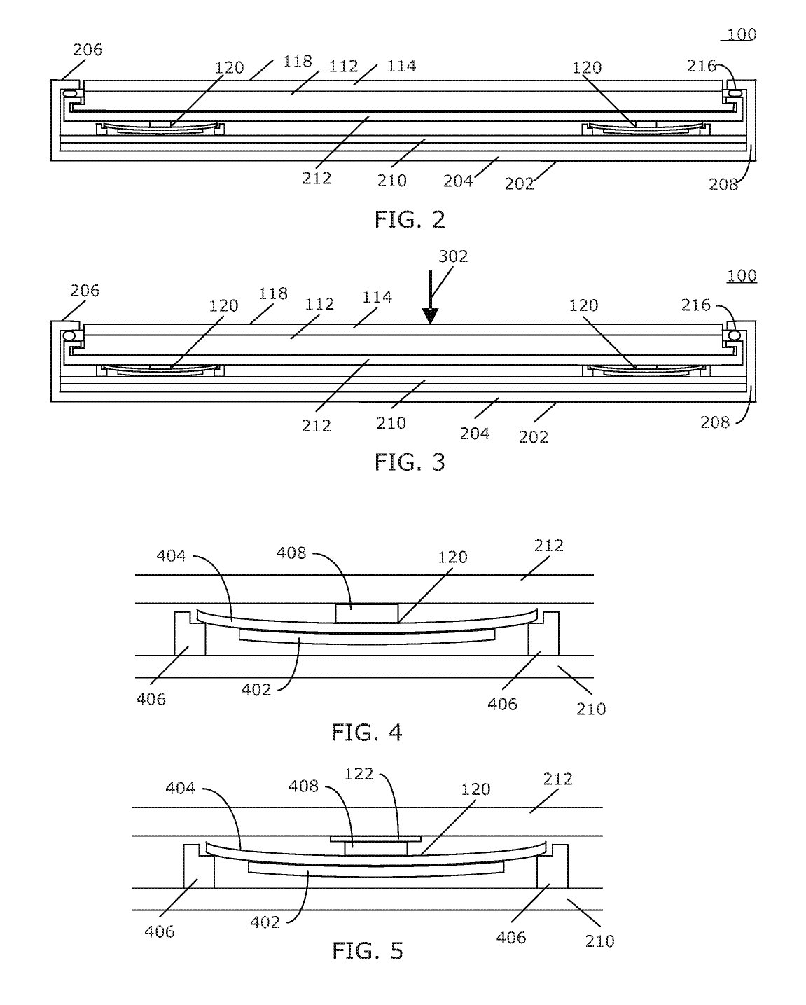

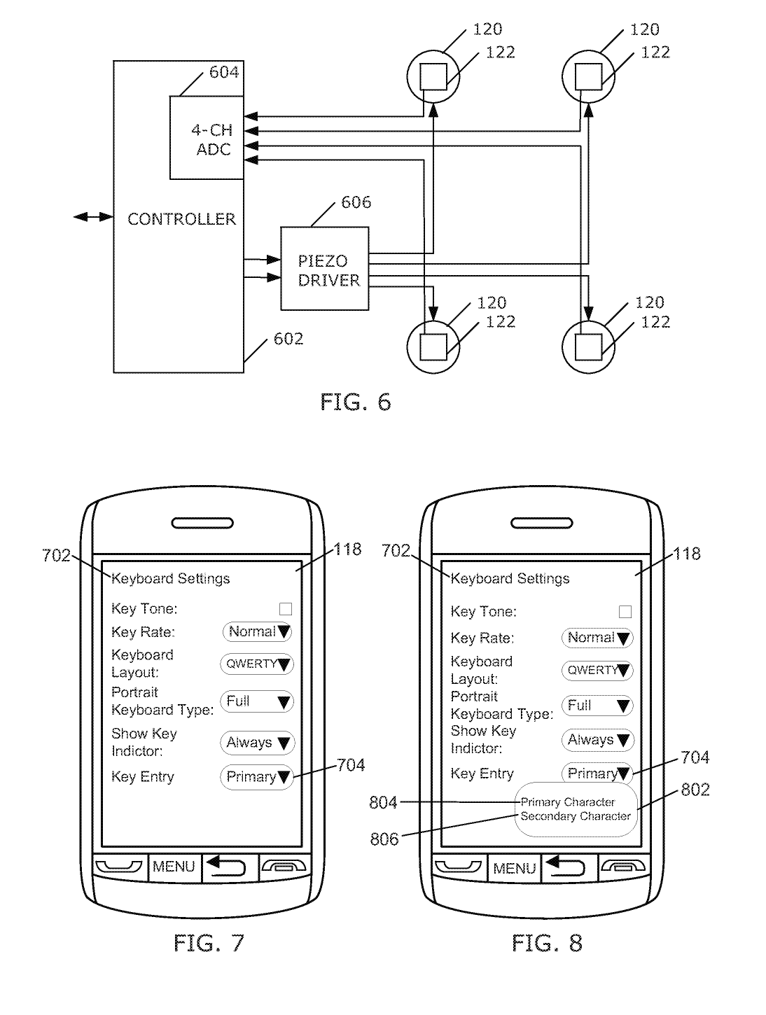

A cross section of a portable electronic device 100 taken through the centers of piezoelectric (“piezo”) actuators 120 is shown in FIG. 2. The portable electronic device 100 includes a housing 202 that encloses components such as shown in FIG. 1. The housing 202 may include a back 204, sidewalls 208, and a frame 206 that houses the touch-sensitive display 118. A base 210 extends between the sidewalls 208, generally parallel to the back 204, and supports the actuators 120. The display 112 and the overlay 114 are supported on a support tray 212 of suitable material, such as magnesium. Optional spacers 216 may be located between the support tray 212 and the frame 206, may advantageously be flexible, and may also be compliant or compressible, and may comprise gel pads, spring elements such as leaf springs, foam, and so forth.

The touch-sensitive display 118 is optionally moveable and depressible with respect to the housing 202, for example, floating with respect to the housing 202. A force 302 applied to the touch-sensitive display 118 moves, or depresses, the touch-sensitive display 118 toward the base 210. When sufficient force is applied, the actuator 120 is depressed or actuated as shown in FIG. 3. The touch-sensitive display 118 may also pivot within the housing to depress the actuator 120. The actuators 120 may be actuated by pressing anywhere on the touch-sensitive display 118. The processor 102 receives a signal when the actuator 120 is depressed or actuated.

A cross section taken through the center of a piezo actuator 120 is shown in FIG. 4. The actuator 120 may comprise one or more piezo devices or elements 402. The piezo actuator 120 is shown disposed between the base 210 and the touch-sensitive display 118. The piezo actuator 120 includes a piezoelectric element 402, such as a piezoelectric ceramic disk, fastened to a substrate 404, for example, by adhesive, lamination, laser welding, and/or by other suitable fastening method or device. The piezoelectric material may be lead zirconate titanate or any other suitable material. Although the piezo element 402 is a ceramic disk in this example, the piezoelectric material may have any suitable shape and geometrical features, for example a non-constant thickness, chosen to meet desired specifications.

The substrate 404, which may also be referred to as a shim, may be comprised of a metal, such as nickel, or any other suitable material such as, for example, stainless steel, brass, and so forth. The substrate 404 bends when the piezo element 402 contracts diametrically, as a result of build up of charge at the piezo element 402 or in response to a force, such as an external force applied to the touch-sensitive display 118.

The substrate 404 and piezo element 402 may be suspended or disposed on a support 406 such as a ring-shaped frame for supporting the piezo element 402 while permitting flexing of the piezo actuator 120 as shown in FIG. 4. The supports 406 may be disposed on the base 210 or may be part of or integrated with the base 210, which may be a printed circuit board. Optionally, the substrate 404 may rest on the base 210, and each actuator 120 may be disposed, suspended, or preloaded in an opening in the base 210. The actuator 120 is not fastened to the support 406 or the base 210 in these embodiments. The actuator 120 may optionally be fastened to the support 406 through any suitable method, such as adhesive or other bonding methods.

A pad 408 may be disposed between the piezo actuator 120 and the touch-sensitive display 118. The pad 408 in the present example is a compressible element that may provide at least minimal shock-absorbing or buffering protection and may comprise suitable material, such as a hard rubber, silicone, and/or polyester, and/or other materials. The pad 408 is advantageously flexible and resilient and may provide a bumper or cushion for the piezo actuator 120 as well as facilitate actuation of the piezo actuator 120 and/or one or more force sensors 122 that may be disposed between the piezo actuators 120 and the touch-sensitive display 118. When the touch-sensitive display 118 is depressed, the force sensor 122 generates a force signal that is received and interpreted by the microprocessor 102. The pad 408 is advantageously aligned with a force sensor 122 to facilitate the focus of forces exerted on the touch-sensitive display 118 onto the force sensors 122. The pads 408 transfer forces between the touch-sensitive display 118 and the actuators 120 whether the force sensors 122 are above or below the pads 408. The pads 408 facilitate provision of tactile feedback from the actuators 120 to the touch-sensitive display 118 without substantially dampening the force applied to or on the touch-sensitive display 118.

A force sensor 122 may be disposed between the piezo actuator 120 and the touch-sensitive display 118 as shown in FIG. 5. The force sensor 122 may be disposed between the touch-sensitive display 118 and the pad 408 or between the pad 408 and the piezo actuator 120, to name a few examples. The force sensor 122 may be a force-sensitive resistor, a strain gauge, a piezoelectric or piezoresistive device, a pressure sensor, or other suitable device. Force as utilized throughout the specification, including the claims, refers to force measurements, estimates, and/or calculations, such as pressure, deformation, stress, strain, force density, force-area relationships, thrust, torque, and other effects that include force or related quantities. A piezoelectric device, which may be the piezo element 402, may be utilized as a force sensor. Other arrangements of one or more force sensors 122 may alternatively be utilized.

Alternatively, a mechanical dome switch actuator (not shown) may be disposed between the base 210 and the touch-sensitive display 118. Tactile feedback may provided when the dome collapses due to imparted force and when the dome returns to the rest position after release of the switch.

Force information related to a detected touch may be utilized to select information, such as information associated with a location of a touch. For example, a touch that does not meet a force threshold may highlight a selection option, whereas a touch that meets a force threshold may select or input that selection option. Selection options include, for example, displayed or virtual keys of a keyboard; selection boxes or windows, e.g., “cancel,” “delete,” or “unlock”; function buttons, such as play or stop on a music player; and so forth. Different magnitudes of force may be associated with different functions or input. For example, a lesser force may result in panning, and a higher force may result in zooming.

Selectable features or keys may be displayed on the touch-sensitive display 118 of the portable electronic device 100. A plurality of keys or features may each be associated with two characters. A touch response associates touches on the touch-sensitive display 118 with each of the two characters. The touch response may be primary character entry or secondary character entry. When the touch response is primary character entry and a force applied to the touch-sensitive display 118, for example, as measured by the force sensor 122, exceeds a threshold value, a primary character of the two characters is associated with a touch on a key or feature. When the touch response is secondary character entry, and a force applied to the touch-sensitive display 118, for example, as measured by the force sensor 122, exceeds the threshold value, a secondary character of the two characters is associated with a touch on a key or feature. The portable electronic device 100 may include an option or selectable feature that may be utilized to set or change the touch response. The touch response may be set or changed utilizing, for example, a menu of the portable electronic device 100.

FIG. 7 and FIG. 8 show an example of entering a touch response through a menu on a portable electronic device 100. In this example, a “Keyboard Settings” menu 702 is displayed in response to selection of an option in a menu (not shown). The “Keyboard Settings” menu 702 may include a plurality of options to customize or modify settings related to data entry utilizing selectable features or keys displayed on the touch-sensitive display 118. In the example of FIG. 7 and FIG. 8, a “Key Entry” option 704 is included in the “Keyboard Settings” menu 702. The “Key Entry” option 704 is utilized in this example to identify the touch response that associates characters with selectable features or keys displayed on the touch-sensitive display 118.

The “Key Entry” option 704 may be utilized to change the touch response between primary character entry and secondary character entry, and optionally any other touch response option. The “Key Entry” option 704 may be selected, for example, by a touch on the touch-sensitive display 118 at a location associated with the “Key Entry” option 704. When a touch is detected at a location associated with the “Key Entry” option 704, a submenu 802 may be displayed on the touch-sensitive display 118. The submenu 802 includes, for example, a “primary character entry” option 804 and a “secondary character entry” option 806. The “Key Entry” options 704 may be set to primary character entry when a touch is detected at a location associated with the “primary character entry” option 804. The “Key Entry” option 704 may be set to secondary character entry when a touch is detected at a location associated with the secondary character entry option 806. Additional character entry options may be similarly utilized.

The touch response may have a default setting of primary character entry or secondary character entry when the portable electronic device 100 is first turned on. The touch response may remain at the default setting or change to the setting selected by the user, for example, when the “Key Entry” option 704 is changed. The touch response may remain at the default setting or the setting selected by the user when the portable electronic device 100 is powered off or enters a sleep condition, state, or mode. In general, the touch response may be maintained until changed.

Entry of a selectable feature or key displayed on the touch-sensitive display 118 is confirmed when the touch response is primary character entry, and a value associated with a force applied to the touch-sensitive display 118 meets a threshold value. A secondary character associated with a selectable key is entered when the touch response is secondary character entry, and a value associated with the force meets the threshold value. A threshold value, as utilized throughout the disclosure, may be a value that is utilized to distinguish between touches based on a value of force applied on the touch-sensitive display 118, for example, to distinguish between a lesser force applied on the touch-sensitive display 118 and a greater force applied on the touch-sensitive display 118. In the example in which a force sensor is utilized, the threshold value may be a predetermined value that is identifiable by the type of force sensor utilized. In the example in which a mechanical dome switch actuator is disposed between the base 210 and the touch-sensitive display 118, the threshold value is a value of force that overcomes the resistance to actuate the mechanical dome switch actuator.

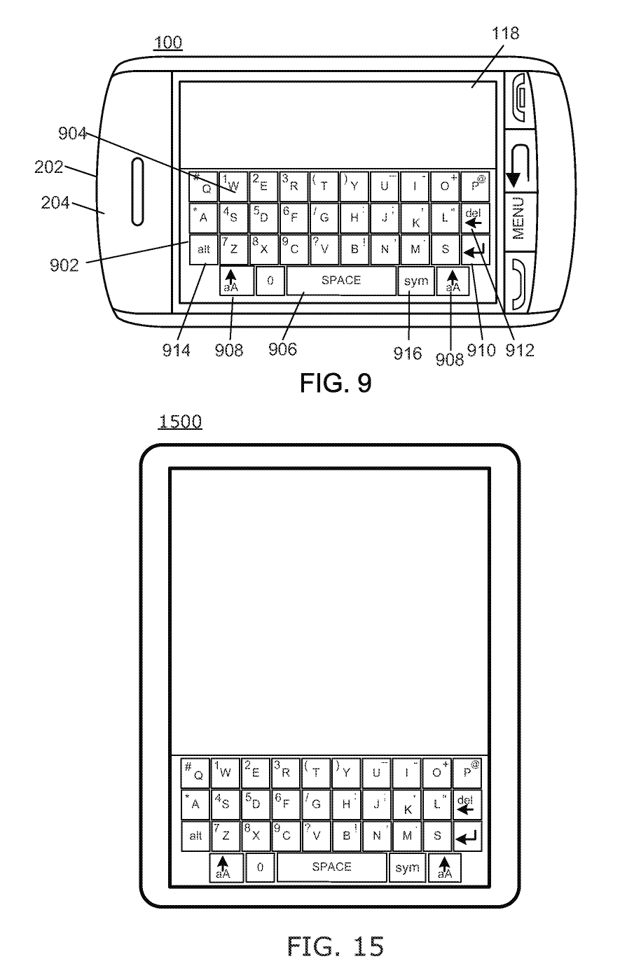

An example of a virtual keyboard 902 displayed on the portable electronic device 100 is shown in FIG. 9. Information associated with an application, such as an electronic mail application, a calendar application, a web browser application, an address book application, or any other suitable application resident on or accessible utilizing the portable electronic device 100, may be displayed on the touch-sensitive display 118. In the example shown in FIG. 9, a virtual keyboard 902 associated with an email application is displayed on the touch-sensitive display 118. Each of the selectable keys 904 of the virtual keyboard 902 is associated with a primary character and a secondary character. The primary character may be one of the letters A through Z. The secondary character may be one of the numerals 1 through 9, punctuation marks, such as a comma, a period, an exclamation point, and a question mark, one or more symbols, and so forth. In this example, nine selectable keys 904 are associated with the letters W, E, R, S, D, F, Z, X, and C. The nine selectable keys 904 are also associated with a respective one of the numerals 1 through 9. Seventeen selectable keys 904 are associated with the letters A, B, G, H, I, J, K, L, M, N, O, P, Q, T, U, V, and Y. The seventeen selectable keys 904 are also associated with punctuation marks or symbols. In the example shown in FIG. 9, the virtual keyboard 902 is a QWERTY keyboard. Other keyboards may be utilized, such as AZERTY, QWERTZ, Dvorak, and so forth.

Although the selectable keys 904 in this example are associated with a numerals 1 through 9, the selectable keys 904 may be associated with numerals 0 through 9 in other examples. The secondary character associated with a selectable key 904 may be an uppercase letter, or an alternative character, for example, a character from another alphabet or language that includes many more characters than the number of selectable keys 904.

In addition to selectable keys 904 associated with a primary character and a secondary character, one selectable key or bar 906 is associated with a space function. The remaining five selectable keys are associated with keyboard functions, including two shift keys 908, a delete or backspace key 910, an enter or return key 912, an alt (alternate) key 916, and a symbol key 918.

The virtual keyboard 902 is displayed in landscape orientation in the example shown in FIG. 2. Four rows of selectable keys 904 are displayed. Additional rows or fewer rows of selectable keys 904 may be displayed. Alternatively, the virtual keyboard 902 may be displayed in a portrait orientation.

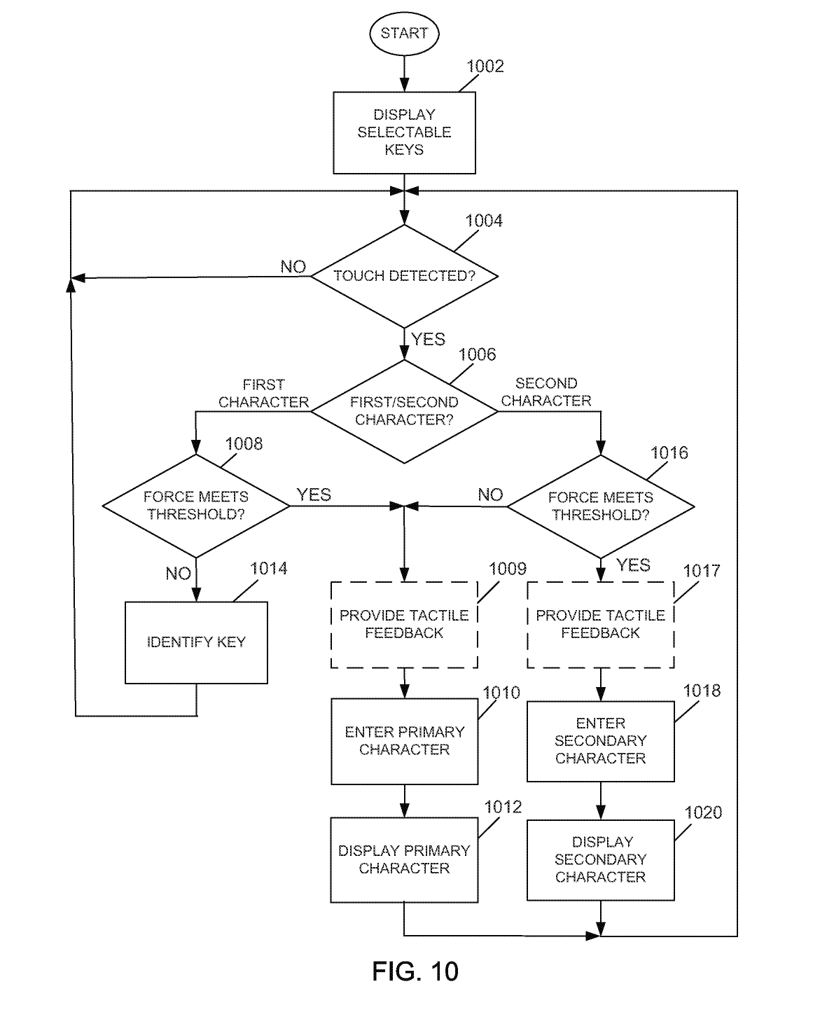

A flowchart illustrating a method of character entry by the portable electronic device 100 is shown in FIG. 10. The method may be carried out by software executed, for example, by the processor 102. Coding of software for carrying out such a method is within the scope of a person of ordinary skill in the art given the present description. The method may contain additional or fewer processes than shown and/or described, and may be performed in a different order. Computer-readable code executable by at least one processor of the portable electronic device to perform the method may be stored in a computer-readable medium, such as a non-transitory computer-readable medium.

Selectable keys of a virtual keyboard, such as the keys 904 of the keyboard 902 or virtual keys in FIG. 15, are displayed 1002. When a touch is detected 1004 on the touch-sensitive display 118, e.g., at a touch location associated with a virtual key of the plurality of virtual keys, the process continues at 1006.

A touch response is identified 1006. When the touch response that is identified 1006 is primary character entry, the process continues at 1008. When the force meets 1008 a threshold, a primary character associated with the selectable key associated with the detected touch is entered 1010 as input, for example, in a data entry field, and the primary character is displayed 1012 on the touch-sensitive display 118. Optionally, tactile feedback may be provided 1009 when the force meets 1008 the threshold.

A force meets the threshold when the value associated with a force applied to the touch-sensitive display 118 during a touch, for example, as measured by the force sensor 122, is equal to or exceeds a threshold value, and the force does not meet the threshold otherwise.

The force may be determined in a number of ways. In an example in which a force sensor 122 is utilized, the force sensor 122 may be a force-sensitive resistor, a strain gauge, a piezoelectric or piezoresistive device, a pressure sensor, and so forth. The force sensor 122 measures a value associated with the force applied to the touch-sensitive display 118. The value may be a force value or another related value suitable for comparing at 1008.

In an example in which a mechanical dome switch actuator is disposed such that the touch-sensitive display 118 actuates the dome switch, the force meets the threshold when the force applied to the touch-sensitive display 118 actuates the mechanical dome switch actuator. The force does not meet the threshold when the mechanical dome switch actuator is not actuated by the force applied to the touch-sensitive display 118.

When the force does not meet 1008 the threshold, the virtual key associated with the detected touch is identified 1014, for example, by temporarily highlighting the virtual key on the virtual keyboard, for example, to identify the key to the user. The virtual key may be highlighted, for example, until the touch on the touch-sensitive display 118 is no longer detected.

When the touch response that is identified 1006 is secondary character entry, the process continues at 1016. When the force meets 1016 the threshold, such as described above, a secondary character associated with the key associated with the detected touch is entered 1018, and the secondary character is displayed 1020 on the touch-sensitive display 118. Optionally, tactile feedback may be provided 1017 when the force meets 1008 the threshold. When the force does not meet 1016 the threshold, the process continues at 1010.

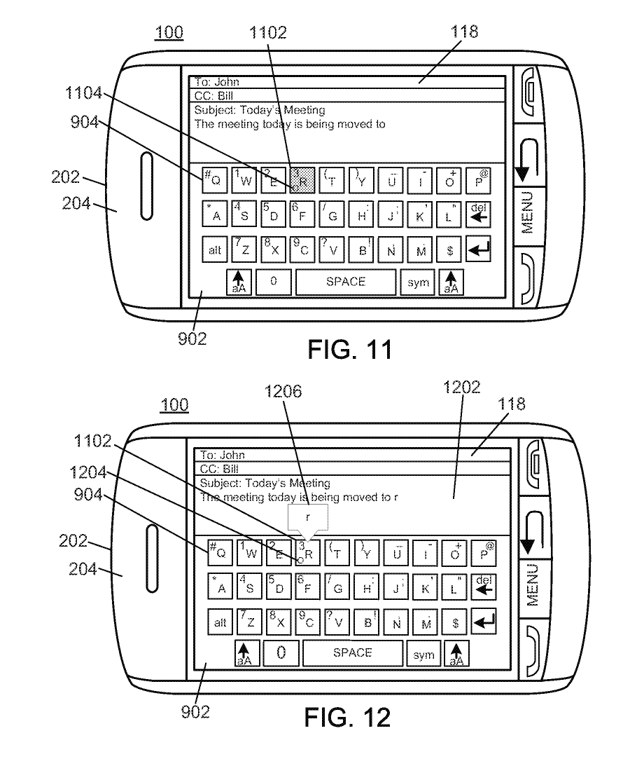

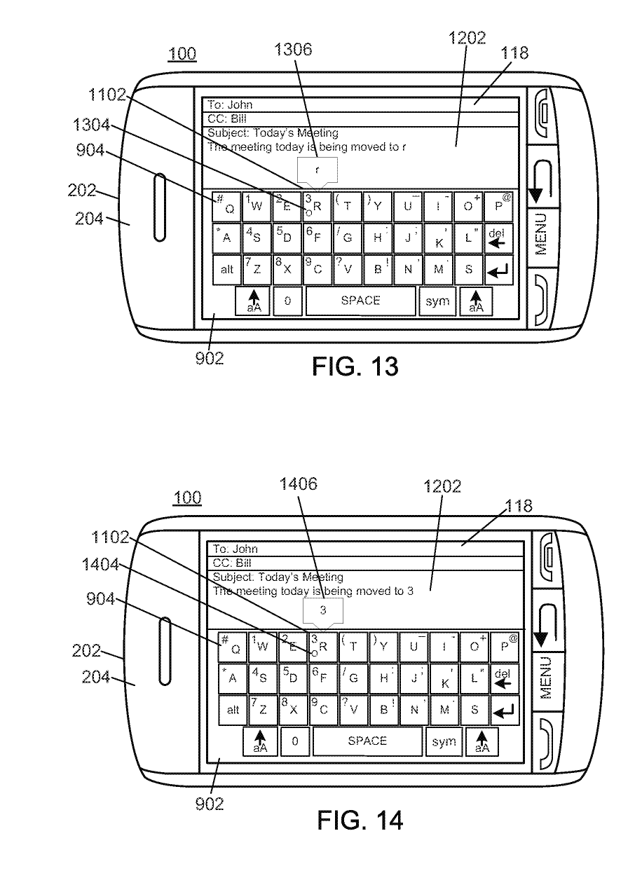

Examples of character entry are illustrated in FIG. 11 through FIG. 14. For the purpose of the present example, the virtual keyboard 902, including the selectable keys 904, is displayed on the touch-sensitive display 118.

For the examples shown in FIG. 11 and FIG. 12, the touch response is primary character entry. In the example of FIG. 11, a touch is detected at the location illustrated by the circle 1104. The location is associated with the selectable key 1102, and a value associated with the force applied to the touch-sensitive display 118 during the touch does not meet the threshold value. The selectable key 1102 is identified and highlighted.

In the example of FIG. 12, a touch is detected at a location illustrated by the circle 1204. The location is associated with the selectable key 1102, and the value associated with the force applied to the touch-sensitive display 118 during the touch meets the threshold value. A primary character, r, associated with the selectable key 1102 is entered and displayed in a data entry field 1202 of the email. In this example, the character associated with the selectable key 1102 is displayed in a preview window 1206. The optional preview window 1206 may be applicable to any of the examples described herein.

For the example of FIG. 13 and FIG. 14, the touch response is secondary character entry. In the example of FIG. 13, a touch is detected at a location illustrated by the circle 1304. The location is associated with the selectable key 1102, and a value associated with the force applied to the touch-sensitive display 118 during the touch does not meet a threshold value. A primary character, r, associated with the selectable key 1102 is entered and displayed in a data entry field 1202 of the email. In this example, the character associated with the selectable key 1102 is displayed in a preview window 1306.

In the example of FIG. 14, a touch is detected at a location illustrated by the circle 1404. The location is associated with the selectable key 1102, and the value associated with the force applied to the touch-sensitive display 118 during the touch meets the threshold value. A secondary character, 3, associated with the selectable key 1102 is entered and displayed in a data entry field 1202 of the email. In this example, the character associated with the selectable key 1102 is displayed in a preview window 1406.

FIG. 15 shows an example of another portable electronic device 1500. In the example of FIG. 15, the portable electronic device 1500 is a tablet computer that is configured to perform the method described above with reference to FIG. 10. The portable electronic device 1500 may include any or all of the hardware and software described with respect to the portable electronic device 100.

A method includes displaying a plurality of keys on a touch-sensitive display and detecting a touch at a touch location associated with a first key of the plurality of keys, identifying a touch response, and when a force associated with the touch meets a threshold, entering a primary character associated with the first key when the touch response is primary character entry, entering a secondary character associated with the first key when the touch response is secondary character entry.

A portable electronic device includes a touch-sensitive display, and a processor coupled to the touch-sensitive display and configured to display a plurality of keys on a touch-sensitive display, detect a touch at a touch location associated with a first key of the plurality of keys, identify a touch response, and when a force associated with the touch meets a threshold, enter a primary character associated with the first key when the touch response is primary character entry, enter a secondary character associated with the first key when the touch response is secondary character entry.

The present disclosure may be embodied in other specific forms without departing from its essential characteristics. The described embodiments are to be considered in all respects only as illustrative and not restrictive. The scope of the present disclosure is, therefore, indicated by the appended claims rather than by the foregoing description. All changes that come with meaning and range of equivalency of the claims are to be embraced within their scope.

What is claimed is:

1. A method comprising:
displaying a plurality of keys on a touch-sensitive display;
detecting a touch at a touch location associated with a first key of the plurality of keys;
identifying a touch response;
when a force associated with the touch meets a threshold:
entering a primary character associated with the first key when the touch response is primary character entry;
entering a secondary character associated with the first key when the touch response is secondary character entry.

2. The method according to claim 1, comprising displaying the entered character.

3. The method according to claim 1, comprising highlighting the first key when the touch response is primary character entry, and the force associated with the touch does not meet the threshold.

4. The method according to claim 1, comprising providing tactile feedback when the force meets the threshold.

5. The method according to claim 1, comprising entering the primary character associated with the first key when the touch response is secondary character entry, and the force associated with the touch does not meet the threshold.

6. The method according to claim 1, comprising displaying, on the touch-sensitive display, a selectable option for changing the touch response to one of primary character entry and secondary character entry.

7. A portable electronic device comprising:
a touch-sensitive display;
a processor coupled to the touch-sensitive display, and configured to:
display a plurality of keys on the touch-sensitive display;
detect a touch at a touch location associated with a first key of the plurality of the keys;
identify a touch response;
when a force associated with the touch meets a threshold:
enter a primary character associated with the first key when the touch is primary character entry;
enter a secondary character associated with the first key when the touch response is secondary character entry.

8. The portable electronic device according to claim 7, wherein the entered character is displayed on the touch-sensitive display.

9. The portable electronic device according to claim 7, wherein the processor is configured to highlight the first key when the touch response is primary character entry, and the force associated with the touch does not meet the threshold.

10. The portable electronic device according to claim 7, wherein tactile feedback is provided when the force meets the threshold.

11. The portable electronic device according to claim 7, wherein the processor is configured to enter the primary character associated with the first key when the touch response is secondary character entry, and the force associated with the touch does not meet the threshold.

12. The portable electronic device according to claim 7, wherein the processor is configured to display a selectable option for changing the touch response to one of primary character entry and secondary character entry.

13. A non-transitory computer-readable medium having computer-readable code executable by at least one processor of the portable electronic device to perform the method of claim 1.
